(19) United States
(12) Patent Application Publication
(10) Pub. No.: US 2026/0233949 A1
(43) Pub. Date: Aug. 13, 2026

(54) SYSTEMS AND METHODS FOR FREIGHT MANIPULATION

(71) Applicant: Walmart Apollo, LLC, Bentonville, AR (US)

(72) Inventors: Tomas A. Blodgett, Fayetteville, AR (US); Gerald J. Byers, Springfield, MO (US); Shane T. Shelbourn, Pea Ridge, AR (US); Swetha Mahadevan, Bentonville, AR (US)

(21) Appl. No.: 19/470,750

(22) PCT Filed: Mar. 28, 2024
(86) PCT No.: PCT/US2024/021892

§ 371 Date: Sep. 29, 2025

Related U.S. Application Data
(60) Provisional application No. 63/456,404, filed on Mar. 31, 2023.
(60) Provisional application No. 63/456,407, filed on Mar. 31, 2023.
(60) Provisional application No. 63/536,608, filed on Sep. 5, 2023.
(60) Provisional application No. 63/536,609, filed on Sep. 5, 2023.

(51) Int. Cl. B65G 47/91; B65G 1/137; B65G 41/00; B65G 61/00

(52) U.S. Cl. CPC B65G 47/91; B65G 41/008; B65G 61/00; B65G 1/1375; B65G 1/1376

(57) ABSTRACT

In some embodiments, systems and methods are provided herein useful to load and/or unload freight. In some embodiments, A system may include a mobile platform, a receiving conveyor on the mobile platform, a receiving conveyor actuator coupled to the receiving conveyor, a pick apparatus attached to the mobile platform. The pick apparatus may pick a first object from a stack of objects and release the first object to the receiving conveyor. The receiving conveyor may move away the first object released thereon from the stack of objects. The pick apparatus may move toward a second object in the stack of objects while the first object on the receiving conveyor is moved away from the stack of objects. The receiving conveyor actuator may change, based at least on a height of the second object, the height of the first portion of the receiving conveyor.

### CROSS-REFERENCE TO RELATED APPLICATIONS

This application claims the benefit of Patent Application Nos. 63/456,404 filed Mar. 31, 2023, 63/456,407 filed Mar. 31, 2023, 63/536,608 filed Sep. 5, 2023, and 63/536,609 filed Sep. 5, 2023, which are incorporated herein by reference in their entirety.

### TECHNICAL FIELD

This invention relates generally to freight unload and load systems.

### BACKGROUND

Freight loading and unloading generally refers to a process within a supply chain that involves the transfer of goods from one form of transportation to another or the transfer of goods to and from a storage area. Loading generally refers to a process of placing goods onto a transport vehicle. Unloading generally refers to a process of removing goods from the transport vehicle upon reaching the destination. In some conventional approaches, freight loading and unloading in a commercial product facility has been a completely manual process.

### BRIEF DESCRIPTION OF DRAWINGS

Disclosed herein are embodiments of systems, apparatuses and methods pertaining to systems and methods for freight loading and unloading. This description includes drawings, wherein:

FIG. 1 is a block diagram of a system for freight manipulation according to some embodiments.

FIG. 2 illustrates an example freight manipulator according to some embodiments.

FIG. 3 illustrates another example of freight manipulator according to some embodiments.

FIG. 4 is a flowchart depicting an example method to manipulate an object in a commercial product facility in accordance with the embodiments described above.

FIG. 5 is a flowchart depicting another example method to unload a stack of objects in a container/trailer in accordance with some embodiments.

FIG. 6 is a flowchart depicting another example method to unload a stack of objects in a container/trailer in accordance with some embodiments.

FIGS. 7A-7H illustrate the freight manipulator in operation in accordance with some embodiments.

FIG. 8 is a flowchart depicting another example method to manipulate objects in a commercial product facility in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, devices, and methods are provided herein useful to manipulate, load, and/or unload objects such as freight, cases, and boxes. In some embodiments, a system for freight manipulation may comprise, a mobile platform comprising a moving mechanism, a receiving conveyor on the mobile platform, wherein a height of a first portion of the receiving conveyor is controllable, a receiving conveyor actuator coupled to the receiving conveyor configured to change the height of the first portion of the receiving conveyor, a pick apparatus attached to the mobile platform, and a control circuit operably coupled to the receiving conveyor, the receiving conveyor actuator, and the pick apparatus, the control circuit configured to cause the pick apparatus to pick a first object from a stack of objects and release the first object to the receiving conveyor with the first portion at a first height, cause the receiving conveyor to move away the first object released thereon from the stack of objects, cause the pick apparatus to move toward a second object in the stack of objects while the first object on the receiving conveyor is moved away from the stack of objects, and cause the receiving conveyor actuator to change, based at least on a height of the second object, the height of the first portion of the receiving conveyor from the first height to a second height before the second object is transferred from the pick apparatus to the receiving conveyor.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

In some aspects, embodiments of systems disclosed herein may provide an efficient and reliable manipulation, loading, and/or unloading of objects such as freight, cases, and boxes. Embodiments of systems disclosed herein may be used in enclosed and/or floor loaded trailers or shipping containers. Embodiments of systems disclosed herein may achieve reliability and an unloading/loading rate that surpasses the manual methods as well as other systems.

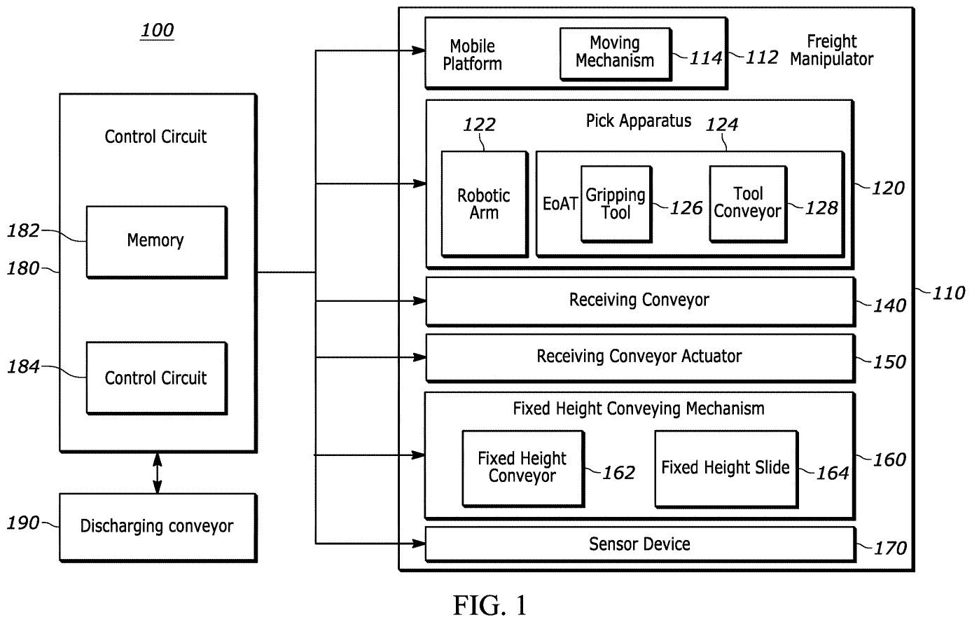

Various embodiments and examples of freight manipulation systems, devices, apparatus, and methods are described herein. Exemplary FIGS. 1-8 are provided to illustrate various embodiments. And it is noted that when describing certain embodiments, certain features may be shown in one or more of FIGS. 1-8.

FIG. 1 is a block diagram of a system 100 for freight manipulation according to some embodiments. The system 100 comprises a freight manipulator 110 and a controller 180.

In some embodiments, the freight manipulator 110 may comprise a mobile platform 112, a pick apparatus 120, a receiving conveyor 140, and a receiving conveyor actuator 150.

The mobile platform 112 may be capable of traversing over a dock plate and into a trailer or container. The mobile platform 112 may move and rotate in all directions by employing a moving mechanism 114. The moving mechanism 114 may comprise driven steering wheels, mecanum-type wheels, tracks, or similar mechanisms.

The pick apparatus 120 may be attached to the mobile platform 112. The pick apparatus 120 may pick an object from a stack of objects and release the picked object to the receiving conveyor 140. The pick apparatus 120 may also pick the object from the receiving conveyor 140 and release the picked object to a stacking area where the objects are to be stacked. The pick apparatus 120 may support the full weight of an object while moving the object between a pick location and a release location.

In some embodiments, the pick apparatus 120 may comprise a robotic arm 122 and an End-of-Arm Tool (EoAT) 124. Mounted to the mobile platform may be a robotic arm 122 and the EoAT 124 may be coupled to the end of the robotic arm 122.

In some embodiments, the robotic arm 122 may be a multi-axis robotic arm. In some embodiments, the robotic arm 122 may be a custom design robotic arm with two or more axis. In some embodiments, the manipulator 210 may have four or six axis. In some embodiments, the robotic arm 122 includes multiple arms that are pivotally, rotatably, and/or statically attached.

The EoAT 124 may grip, hold, and/or support the object while the robotic arm 122 moves the EoAT 124. While the robotic arm 122 moves the EoAT 124, the EoAT 124 may support a full weight of an object. Various types of EoATs may be used to grip, hold, and/or support the object and move the object independently or together with the robotic arm.

In some embodiments, the EoAT 124 may include a gripping tool 126 to grip an object. In some embodiments, the gripping tool 126 may include a suction cup, suction cup array and/or a suction pad to grip an object. In some embodiments, the suction pad may be an open-cell foam suction pad. In some embodiments, the gripping tool 126 may comprise a plurality of suction cup arrays. In some embodiment, two of the plurality of suction cup arrays may be opposite to each other. In some embodiments, the gripping tool 126 may include pin arrays and/or other types of gripping mechanisms that can grip an object.

In some embodiments, the EoAT 124 may further include a tool conveyor 128 to support the object gripped by the gripping tool 126. In some embodiments, the gripping tool 126 and the tool conveyor 128 may be coupled to the robotic arm 122 via a base or frame. For example, the gripping tool 126 and the tool conveyor 128 may be coupled to the base and the base may be directly mounted to the end of robotic arm 122. The tool conveyor 128 has a conveyor surface configured to move an object thereon. The tool conveyor 128 is configured to move the object on the conveyor surface between edges at opposite sides of the tool conveyor 128. In some embodiments, the tool conveyor 128 may be, but not limited to, a motorized conveyor.

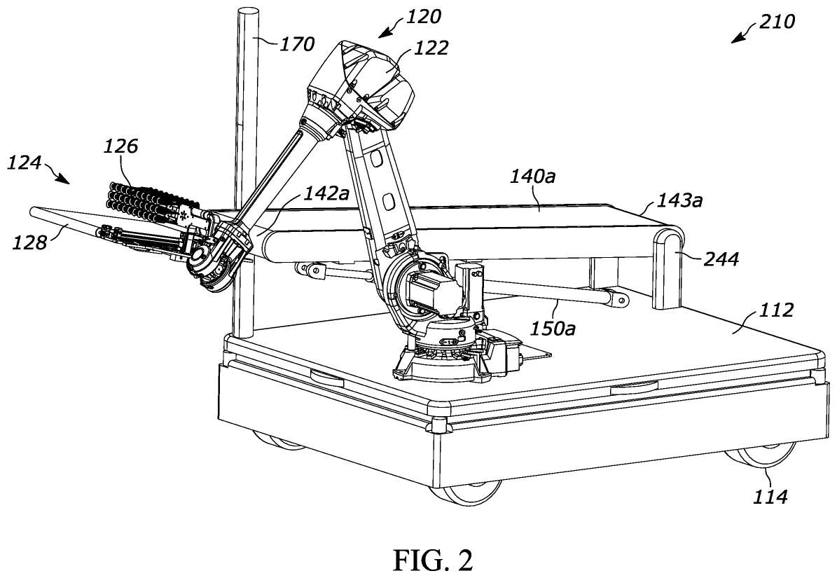

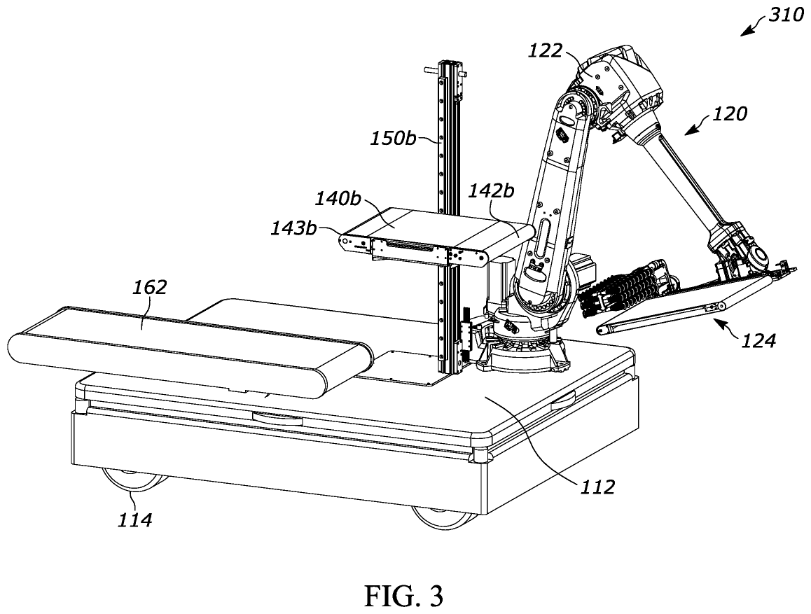

The receiving conveyor 140 has a conveyor surface configured to move an object on the conveyor surface. The receiving conveyor 140 is configured to move the object thereon between edges (see 142a, 143a in FIGS. 2 and 142b, 143b in FIG. 3) at opposite sides of the receiving conveyor 140. In some embodiments, the receiving conveyor 140 may be, but not limited to, a motorized conveyor.

The receiving conveyor 140 may be on the mobile platform 112. In some embodiments, the receiving conveyor 140 may be movably mounted to the mobile platform 112. In an unloading scenario, the pick apparatus 120 may release a picked object to the receiving conveyor 140 such that the object picked by the pick apparatus 120 may be transferred to the receiving conveyor 140. In a loading scenario, the pick apparatus 120 may pick an object on the receiving conveyor such that the object may be transferred from the receiving conveyor 140 to the pick apparatus 120.

The receiving conveyor 140 includes a height adjustable portion. The height of the height adjustable portion of the receiving conveyor 140 is adjustable and/or controllable. In some embodiments, the height adjustable portion of the receiving conveyor 140 may include a portion where the pick apparatus 120 and receiving conveyor 140 transport an object therebetween. For example, an object may be transferred between the receiving conveyor 140 and the pick apparatus 120 via a pick apparatus approaching edge (142a in FIG. 2 and 142b in FIG. 3) of the receiving conveyor 140. Among the edges between which the receiving conveyor 140 moves an object, the pick apparatus approaching edge may refer to the edge at or adjacent to the position where an object is transferred between the pick apparatus 120 and receiving conveyor 140. In some embodiments, the height adjustable portion of the receiving conveyor 140 may include the pick apparatus approaching edge 142a, 142b. In some embodiments, the pick apparatus approaching edge 142a, 142b may face the stack of objects or stacking area. In some embodiments, the entire receiving conveyor 140 may be height adjustable.

In some embodiments, the height of the height adjustable portion of the receiving conveyor 140 may be determined based on the pick location of an object in the stack. For example, the height of the pick apparatus approaching edge 142a, 142b of receiving conveyor 140 may match or be close to the height of a bottom surface of an object to be picked by the pick apparatus 120. In some embodiments, the height of the height adjustable portion of the receiving conveyor 140 may be determined and controlled based on a pick location of an object to be picked from the stack of objects and a pick location of a next object to be picked from the stack of objects.

In some embodiments, the height of the height adjustable portion of the receiving conveyor 140 may be determined based on a total distance between a pick location of an object and the receiving conveyor 140 and between the receiving conveyor 140 and a pick location of a next object being picked. For example, the height of the pick apparatus approaching edge 142a, 142b of the receiving conveyor 140 may be determined based on minimizing a total distance between a pick location of an object and the receiving conveyor 140 and between the receiving conveyor 140 and a pick location of a next object being picked within the scope of the height adjustment.

The height of the receiving conveyor 140 may be adjusted and changed with the receiving conveyor actuator 150 coupled to the receiving conveyor 140. In some embodiments, the receiving conveyor actuator 150 may move up and down the receiving conveyor 140. In some embodiments, the receiving conveyor actuator 150 may tilt the receiving conveyor 140 relative to the mobile platform 112. In some embodiments, the receiving conveyor 140 may be further configured to move forward, backward, and/or sideways with the receiving conveyor actuator 150.

In some embodiments, the pick apparatus 120, the receiving conveyor 140, the receiving conveyor actuator 150 are mounted to the mobile platform 112 such that when the mobile platform 112 traverses, the pick apparatus 120, the receiving conveyor 140, and the receiving conveyor actuator 150 may be moved together with the mobile platform 112.

In some embodiments, the freight manipulator 110 may further comprise a fixed height conveying mechanism 160 attached to the mobile platform 112. The fixed height conveying mechanism may comprise a fixed height conveyor 162, a fixed height slide 164, and/or a combination thereof. The fixed height conveyor 162 has a conveyor surface configured to move an object thereon. The fixed height conveyor 162 is configured to move the object thereon between edges on opposite sides of the fixed height conveyor 162. In some embodiments, the fixed height conveyor 162 may be, but not limited to, a motorized conveyor. In some embodiments, the fixed height conveyor 162 may receive an object from the receiving conveyor 140 and/or transfer an object on the fixed height conveyor 162 to the receiving conveyor 140. For example, in freight unload scenario, the object released to the receiving conveyor 140 by the pick apparatus may be transferred from the receiving conveyor 140 to the fixed height conveyor 162. In freight load scenario, the object may be transferred from the fixed height conveyor 162 to the receiving conveyor 140 and then, the object transferred to the receiving conveyor 140 may be picked by the pick apparatus 120 and moved to a stacking area in a trailer/container. The fixed height slide 164 has a slide surface with which an object moves in contact. The object on the slide may be moved between one end of the slide surface and the other end of the slide surface. In some embodiments, the slide surface may be sloped such that when an object is released on the slide surface, the object may move toward the lower portion of the slide surface by gravity. In some embodiments, the higher end of the slide surface may be in alignment with or close to the receiving conveyor 140. For example, in unloading scenario, the object released to the receiving conveyor 140 by the pick apparatus 120 may be transferred from the receiving conveyor 140 to the slide surface of the fixed height slide 164 and the object released on the fixed height slide 164 may move toward the lower portion of the slide surface.

In some embodiments, the freight manipulator 110 may further include one or more sensor devices 170 configured to recognize object height and capture an image of the stack of object or the object stacking area. The sensor devices 170 may be a camera, an imaging sensor, a depth sensor, an infrared sensor, 3D sensors, or other imaging devices. The sensor devices 170 may use various image recognition and image processing techniques. The sensor devices 170 may scan or capture images in front of the freight manipulator 110 in real-time or near real-time. In some embodiments, the sensor devices 170 may be mounted to the top surface of the mobile platform 112.

In some embodiments, the system 100 may further include a discharging conveyor 190 configured to receive the object from the freight manipulator 110 and/or transfer the object on the discharging conveyor 190 to the freight manipulator 110. In some embodiments, the discharging conveyor 190 may receive the object from the receiving conveyor 140 and/or transfer an object on the discharging conveyor 190 to the receiving conveyor 140. When the freight manipulator 110 further includes the fixed height conveyor 162, the discharging conveyor 190 may receive the object from the fixed height conveyor 162 and/or transfer an object on the discharging conveyor 190 to the fixed height conveyor 162. In some configurations, one end of the discharging conveyor may be in alignment with the receiving conveyor 140 or the fixed height conveyor 162 and the other end of the discharging conveyor 190 may be extend beyond the container/trailer. In some embodiments, the discharging conveyor 190 may be an extendable conveyor.

The controller 180 may be housed within the freight manipulator 110. The controller 180 may also be partially or wholly remote with respect to the freight manipulator 110.

The controller 180 may comprise a memory 182 and a control circuit 184. The control circuit 184 may operably couple to the mobile platform 112, pick apparatus 120, receiving conveyor 140, and receiving conveyor actuator 150. When the system 100 further includes the fixed height conveyor 162, the sensor device 170, and/or the discharging conveyor 190, the control circuit 184 may also operably coupled to and control the fixed height conveyor 162, the sensor device 170, and/or the discharging conveyor 190.

The memory 182 may store data and codes to operate the system 100. The memory 182 may comprise but is not limited to non-volatile memory such as read-only memory (ROM) and/or volatile memory such as an erasable programmable read-only memory (EPROM). The control circuit 184 may access the memory 182 and execute the codes stored in the memory 182, for example, by using the corresponding programming as will be well understood by those skilled in the art.

In some embodiments, the control circuit 184 may operably couple to the memory 182. In some embodiments, the memory 182 may be integral to the control circuit 184 or may be physically discrete in whole or in part from the control circuit 184 as desired. This memory 182 may also be local with respect to the control circuit 184 (where, for example, both share a common circuit board, chassis, power supply, and/or housing) or may be partially or wholly remote with respect to the control circuit 184 (where, for example, the memory is physically located in another housing).

In some embodiments, the controller 180 may be operably connected to and control the freight manipulator 110. However, it is understood that the controller 180 may control freight manipulators differently configured, not limited to but including a freight manipulator 210 in FIG. 2 and a freight manipulator 310 in FIG. 3. The control circuit 184 may control each device, apparatus, and component of the system 100 by sending electrical signals to each of them. The control circuit 184 is configured (for example, by using corresponding programming as will be well understood by those skilled in the art) to carry out one or more of the steps, actions, and/or functions described herein by causing the devices, apparatuses, and components of the system 100 to move, actuate, and operate to carry out the steps, actions, and/or functions.

FIG. 2 illustrates an exemplary freight manipulator 210 according to some embodiments. Referring to FIG. 2, in some embodiments, the freight manipulator 210 may comprise the mobile platform 112, the pick apparatus 120, a tilting conveyor 140a, a tilting conveyor actuator 150a, and the sensor device 170. As shown in FIG. 2, in some embodiments, the receiving conveyor 140 may be the tilting conveyor 140a, and the receiving conveyor actuator 150 may be the tilting conveyor actuator 150a.

The tilting conveyor 140a has a conveyor surface configured to move an object on the conveyor surface. The tilting conveyor 140a is configured to move the object thereon between edges 142a, 143a on opposite sides of the tilting conveyor 140a. For example, the tilting conveyor 140a may move the object thereon between a pick apparatus approaching edge 142a and the opposite edge 143a. In an unloading scenario, the pick apparatus 120 may release a picked object to the tilting conveyor 140a and in a loading scenario, the pick apparatus 120 may pick an object from the tilting conveyor 140a.

In some embodiments, the tilting conveyor 140a may be tiltably connected to the mobile platform 112. At least a portion of the tilting conveyor 140a is securely fixed to the mobile platform 112 and the tilting conveyor 140a may be tilted by pivoting about the fixed portion. The fixed portion of the tilting conveyor 140a may have a fixed height. In some embodiments, one end (or edge) 143a of the tilting conveyor 140a may be anchored to the mobile platform 112 directly or via one or more supporting structure 244 and the tilting conveyor 140a may pivot or rotate about the anchored edge 143a. By pivoting the tilting conveyor 140a, the other end (corresponding to the pick apparatus approaching edge 142a) of the tilting conveyor 140a may be dynamically positioned at various heights based on the locations of objects being picked by the pick apparatus 120 such that the robot motion of the pick apparatus 120 to move the objects from the pick location to the release location may be reduced. The anchored edge 143a of the tilting conveyor 140a may have a fixed height. The height of the non-fixed open edge 142a of the tilting conveyor 140a may be controlled based on a pick location of an object in a stack of objects and a pick location of a next object being picked from the stack of objects. For example, the tilting conveyor 140a may rotate to put the non-fixed open edge 142a of the tilting conveyor 140a at a height minimizing a total distance between a pick location of an object and the tilting conveyor 140a and between the tilting conveyor 140a and a pick location of a next object being picked.

In some embodiments, the pick apparatus approaching edge 142a of the tilting conveyor 140a may not extend outside of an area corresponding to the mobile platform 112. For example, the pick apparatus approaching edge 142a of the tilting conveyor 140a may be disposed within the area corresponding to the boundary of the top surface of the mobile platform 112.

When the system 100 further includes the discharging conveyor 190, the edge 143a opposite to the pick apparatus approaching edge 142a may be in alignment with an edge of the discharging conveyor 190.

The tilting conveyor actuator 150a may be configured to tilt/rotate the tilting conveyor 140a relative to the mobile platform 112. The tilting conveyor actuator 150a may be fixed to the mobile platform 112 and mechanically coupled to the tilting conveyor 140a. In some embodiments, one end of the tilting conveyor actuator 150a is fixed to the mobile platform 112 and the other end of the tilting conveyor actuator 150a is fixed to the tilting conveyor 140a. In some embodiments, the tilting conveyor actuator 150a may tilt/rotate the tilting conveyor 140a by changing (e.g., extending or shortening) the total length of the tilting conveyor actuator 150a. The tilting conveyor actuator 150a may also tilt/rotate the tilting conveyor 140a with other methods or mechanisms.

Referring to FIG. 2, in some embodiments, the sensor device 170 may be disposed adjacent to a front edge of the mobile platform 112 such that sensor device 170 may capture the image in front of the freight manipulator 110. In some embodiments, the sensor device 170 may be disposed on the opposite side of the pick apparatus 120 (e.g., robotic arm 122) relative to the receiving conveyor 140 (e.g., the tilting conveyor 140a). By disposing the sensor device 170 on the opposite side of the pick apparatus 120, the pick apparatus 120 may be moved with the minimized or reduced disturbance caused by the sensor device 170.

FIG. 3 illustrates another example of freight manipulator 310 according to some embodiments. In some embodiments, the freight manipulator 310 may comprise the mobile platform 112, the pick apparatus 120, an elevating conveyor 140b, an elevating conveyor actuator 150b, and the fixed height conveyor 162. As shown in FIG. 3, in some embodiments, the receiving conveyor 140 may be the elevating conveyor 140b, and the receiving conveyor actuator 150 may be the elevating conveyor actuator 150b.

The elevating conveyor 140b has a conveyor surface configured to move an object thereon between its edges on opposite sides. For example, the elevating conveyor 140b may move the object thereon between a pick apparatus approaching edge 142b and the opposite edge 143b. In an unloading scenario, the pick apparatus 120 may release a picked object to the elevating conveyor 140b and in a loading scenario, the pick apparatus 120 may pick an object from the elevating conveyor 140b.

In some embodiments, the elevating conveyor 140b may be movably mounted to the mobile platform 112 via the elevating conveyor actuator 150b. For example, mounted directly to the mobile platform 112 may be the elevating conveyor actuator 150b and the elevating conveyor 140b may be coupled to the elevating conveyor actuator 150b.

In some embodiments, the elevating conveyor actuator 150b may raise and lower the elevating conveyor 140b such that the elevating conveyor 140b may move up and down. While moving up and down, the conveyor surface of the elevating conveyor 140b may be kept horizontal. In some embodiments, the elevating conveyor 140b only moves vertically to the top surface of the mobile platform 112. The elevating conveyor actuator 150b may lift and lower the elevating conveyor 140b by various mechanisms. In one example, the elevating conveyor actuator 150b may include a slide and a screw (e.g., a lead screw or a ball screw) driven by a motor. In this example, the elevating conveyor 140b be attached to the slide and move along the screw.

By lifting or lowering the elevating conveyor 140b, the elevating conveyor may be dynamically positioned at various heights based on the locations of objects being picked by the pick apparatus 120 such that the robot motion of the pick apparatus 120 to move the objects from the pick location to the release location may be reduced.

The height of the elevating conveyor 140b may be controlled based on a pick location of an object in the stack and a pick location of a next object in the stack. For example, the height of the elevating conveyor 140b may be determined based on minimizing a total distance between a pick location of an object and the elevating conveyor 140b and between the elevating conveyor 140b and a pick location of a next object being picked. When conveyor surface of the elevating conveyor 140b is not horizontal, the height of the elevating conveyor 140b may be determined based on the height of the pick apparatus approaching edge 142b.

In some embodiments, the pick apparatus approaching edge 142b of the elevating conveyor 140b may not extend outside of an area corresponding to the mobile platform 112. For example, the pick apparatus approaching edge 142b of the elevating conveyor 140b may be disposed within the area corresponding to the boundary of the top surface of the mobile platform 112.

In the embodiment of FIG. 3, the fixed height conveyor 162 may receive an object from the elevating conveyor 140b in an unloading scenario. In a loading scenario, the fixed height conveyor 162 may transfer the object on its conveyor surface to the elevating conveyor 140b. In some embodiments, when an object is transferred from the elevating conveyor 140b to the fixed height conveyor 162 or from the fixed height conveyor 162 to the elevating conveyor 140b, the edge 143b of the elevating conveyor 140b may be in alignment with one edge of the fixed height conveyor 162. In some embodiments, the elevating conveyor 140b may be in alignment with the fixed height conveyor 162 when the elevating conveyor 140b is in a lowest position.

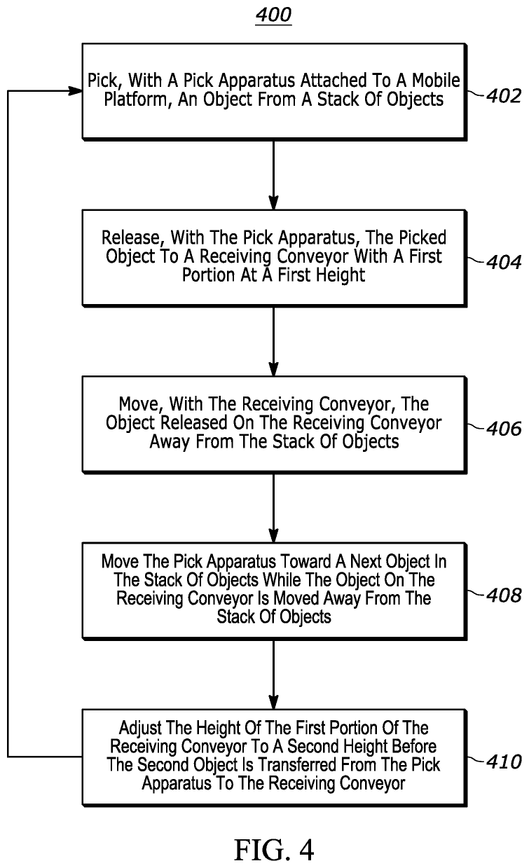

FIG. 4 is a flowchart depicting an exemplary method 400 to manipulate an object in a commercial product facility that may be performed using the system 100 in accordance with the embodiments described above. Although the method 400 is mainly illustrated with the system 100 including the freight manipulator 110, the method 400 may also be performed with the system 100 including the freight manipulator 210 or 310. The method 400 may be performed to unload cases from a container/trailer from a stack of objects. The flow begins at step 402.

In step 402, the pick apparatus 120 picks an object from a stack of objects. To pick the object, the robotic arm 122 may move the EoAT 124 toward the object, and the EoAT 124 may pick the object. In some embodiments, the EoAT 124 may comprise the gripping tool 126 and may pick the object using the gripping tool 126. The gripping tool 126 may grip the case by applying a vacuum suction force to the surface of the case. In some embodiments, the vacuum suction force may be applied with a suction cup array, a suction pad, or a combination thereof. In some embodiments, the gripping tool 126 may grip the case with other types of mechanisms. When the EoAT 124 includes the tool conveyor 128, the gripping tool 126 may put the gripped object onto the tool conveyor 128 and the tool conveyor 128 may support at least a part or entire weight of the object while the picked object is held by the EoAT 124.

In step 404, the pick apparatus 120 releases the picked object to the receiving conveyor 140. To release the picked object to the receiving conveyor 140, the robotic arm 122 may move the EoAT 124 of the pick apparatus 120 toward the receiving conveyor 140. Then, the pick apparatus 120 may release the picked object to the receiving conveyor 140 with the pick apparatus approaching edge 142a, 142b at a first height. For example, the pick apparatus 120 may release the picked object at or adjacent to the pick apparatus approaching edge 142a, 142b at the first height. In some embodiments, when the EoAT 124 does not include the tool conveyor 128, the pick apparatus 120 may release the object by removing the gripping force applied to the object. When the EoAT 124 includes the tool conveyor 128. The picked object may be released to the receiving conveyor 140 by the tool conveyor 128 transferring the object on its surface to the receiving conveyor 140. But again, the other mechanisms or methods to pick and release an object may be used for steps 402 and 404.

In step 406, the receiving conveyor 140 moves the object released to the receiving conveyor 140. The receiving conveyor 140 moves the released object away from the stack of objects by moving the released object from the released point which is at or near the pick apparatus approaching edge of the receiving conveyor 140 to the opposite edge of the receiving conveyor 140 which is further away from the stack of objects than the pick apparatus approaching edge of the receiving conveyor 140.

In step 408, the pick apparatus 120 may move toward a next object in the stack of objects. For example, the robotic arm 122 moves the EoAT 124 toward the next object in the stack of objects. Before moving toward the next object, the system, with the control circuit 184, may determine the next object to be picked. To determine the next object to be picked, the control circuit 184 may use the information captured by the one or more sensor devices 170. In some embodiments, the pick apparatus 120 moves toward the next object in the stack of objects while the object released on the receiving conveyor 140 is moved away from the stack of objects.

In step 410, the height of the pick apparatus approaching edge of the receiving conveyor 140 is adjusted. The height of the pick apparatus approaching edge of the receiving conveyor 140 may be adjusted with the receiving conveyor actuator 150 from the first height to a second height. In some embodiments, the height adjustment from the first height to the second height may be a direct adjustment, i.e., the height is directly changed from the first height to the second height. In some embodiments, the height adjustment from the first height to the second height may be an indirect adjustment, i.e., the height is changed from the first height to the second height via a third height which is different from the first and second heights. For example, the height of the pick apparatus approaching edge of the receiving conveyor 140 is changed from the first height to the lowest height of the pick apparatus approaching edge and then changed from the lowest height to the second height. In some embodiments, the control circuit 184 determines and controls the height of the pick apparatus approaching edge of the receiving conveyor 140 based on the recognized height of the object to be picked which the pick apparatus 120 is moving toward. In some embodiments, the control circuit 184 determines and controls the height of the pick apparatus approaching edge of the receiving conveyor 140 based on the object which the pick apparatus 120 is moving toward to pick and the next object to be picked after picking the object which the pick apparatus 120 is currently moving toward. In some embodiments, the height of the pick apparatus approaching edge of the receiving conveyor 140 may be adjusted while one more of the steps 406 and 408 are conducted.

Steps 402 to 410 may be repeated to manipulate a plurality of objects. For example, the flow may continue after step 410, going back to step 402. Steps 402 to 410 may be repeated as many times as necessary. For example, steps 402 to 410 may be repeated until there remain no objects the system 100 should manipulate according to the method 400, or until the system 100 identifies no object to be picked.

According to the illustrated embodiments, the system may manipulate objects with minimized or reduced movement of the pick apparatus 120. For example, the system 100 according to some embodiments may reduce or minimize the change of the orientation/position of the robotic arm 122 and the EoAT 124 to grip an object from the stack of objects and release the gripped object to the object-release location. This allows the system to operate at a higher rate, reduce robotic manipulator motion, and significantly reduce cycle time of manipulation of an object.

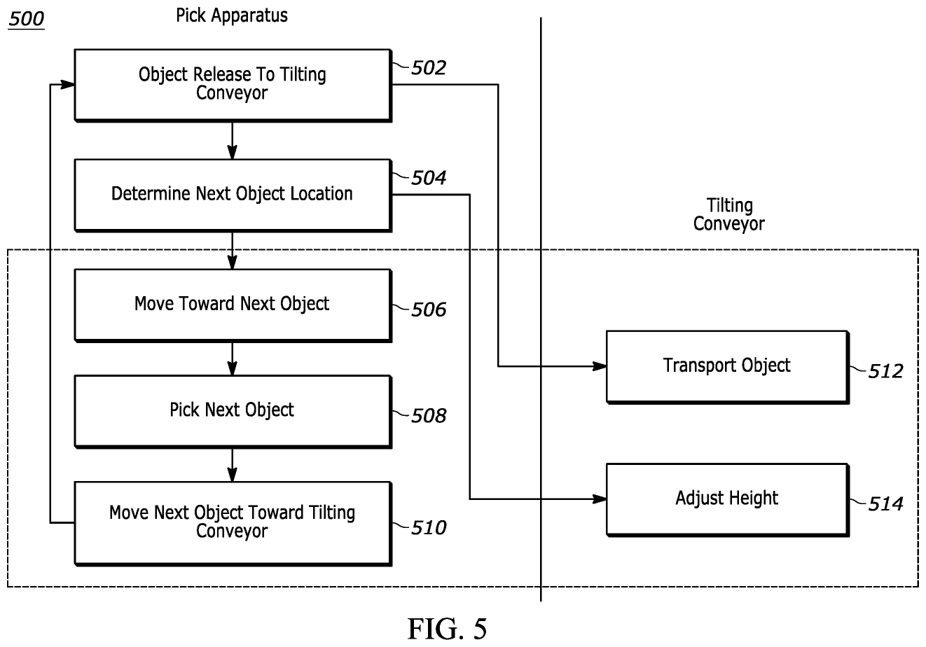

FIG. 5 is a flowchart depicting another exemplary method 500 to unload a stack of objects in a container/trailer that may be performed using the system 100 including the freight manipulator 210 (see FIG. 2).

In step 502, the pick apparatus 120 releases an object that the pick apparatus 120 has picked from the stack of objects to the tilting conveyor 140a. The pick apparatus 120 may release the object to the tilting conveyor 140a via the non-fixed open edge 142a (i.e., pick apparatus approaching edge) of the tilting conveyor 140a or the portion adjacent to at the non-fixed open edge 142a. When the pick apparatus 120 releases the object to the tilting conveyor 140a, the height of the non-fixed open edge 142a of the tilting conveyor 140a may be at a first height. The flow may continue in step 504 and step 512.

In step 504, the system 100 determines the location of the next object that the pick apparatus 120 will pick. In step 504, the system 100 may use the information captured by the one or more sensor devices 170. In step 506, the pick apparatus 120 moves toward the next object. After the pick apparatus 120 reaches the pick location of the next object, in step 508 the pick apparatus picks the next object. In step 510, the pick apparatus 120 moves the picked next object toward the tilting conveyor 140a to release the picked next object to the tilting conveyor 140a once the pick apparatus 120 reaches the receiving conveyor 140. After step 510, the flow may continue by going back to step 502.

In step 512, the tilting conveyor 140a may transport the object released to the tilting conveyor 140a from the released point to the next location via the anchored edge 143a. After step 504, the flow may also continue in step 514. In step 514, the tilting conveyor 140a may adjust, with the tilting conveyor actuator 150a, the height of the non-fixed open edge 142a (i.e., pick apparatus approaching edge) of the tilting conveyor 140a. In some embodiments, the height of the non-fixed open edge 142a may be adjusted from the first height to a second height. The tilting conveyor may adjust the height of the non-fixed open edge 142a while the tilting conveyor 140a moves the object thereon in step 512. In some embodiments, steps 512 and 514 may occur concurrently as one or more of the steps 506, 508, and 510. Steps 502 to 514 may be repeated as many times as necessary.

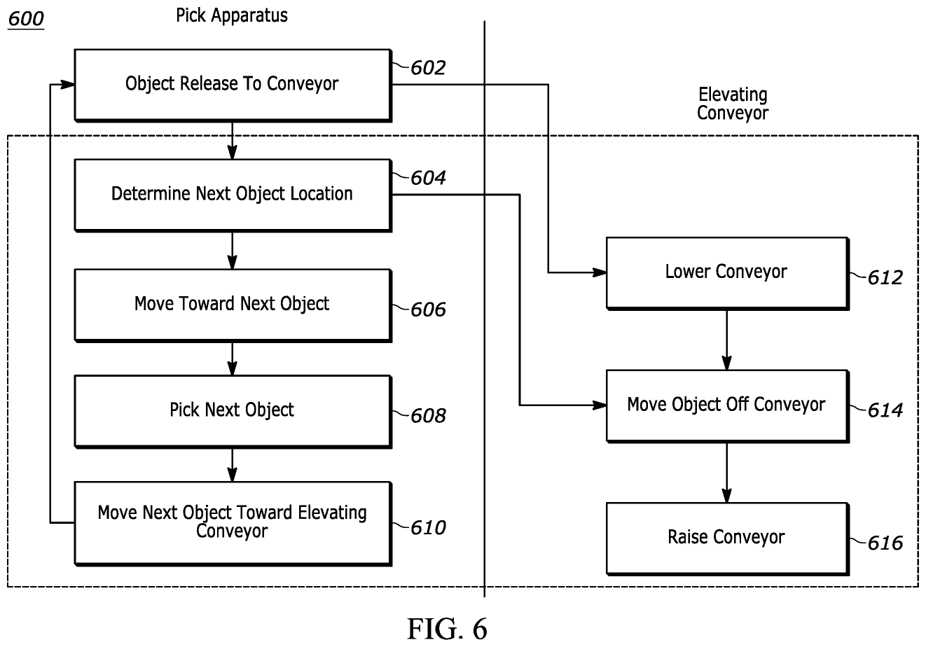

FIG. 6 is a flowchart depicting another exemplary method 600 to unload a stack of objects in a container/trailer that may be performed using the system 100 including the freight manipulator 310 (see FIG. 3).

In step 602, the pick apparatus 120 releases an object that the pick apparatus has picked from the stack of objects to the elevating conveyor 140b. The pick apparatus 120 may release the object to the elevating conveyor 140b via the edge 142b that is facing the stack of objects or the portion adjacent to at the edge 142b. When the pick apparatus 120 releases the object to the elevating conveyor 140b, the elevating conveyor 140b may be at a first height. The flow may continue in step 604 and step 612.

In step 604, the system 100 determines the location of the next object that the pick apparatus 120 will pick. In step 604, the system 100 may use the information captured by the one or more sensor devices 170. In step 606, the pick apparatus moves toward the next object. Once the pick apparatus 120 reaches the pick location of the next object, the pick apparatus 120 picks the next object in step 608. In step 610, the pick apparatus 120 moves the picked next object toward the elevating conveyor 140b to release the picked next object to the elevating conveyor 140b once the pick apparatus 120 reaches the receiving conveyor 140. After step 610, the flow may continue by going back to step 602.

In step 612, the elevating conveyor actuator 150b may lower the elevating conveyor 140b. In step 612, the elevating conveyor actuator 150b may lower the elevating conveyor to the lowest position. In some embodiments, at the lowest position, the elevating conveyor 140b is in alignment with the fixed height conveyor 162. In step 614, the elevating conveyor 140b moves the object thereon off the elevating conveyor 140b. In some embodiments, the elevating conveyor 140b may transfer the object thereon to the fixed height conveyor 162. In step 616, the elevating conveyor actuator 150b may raise the elevating conveyor 140b to the second height. In some embodiments, steps 612, 614, and 616 may occur concurrently as one or more of the steps 604, 606, 608, and 610.

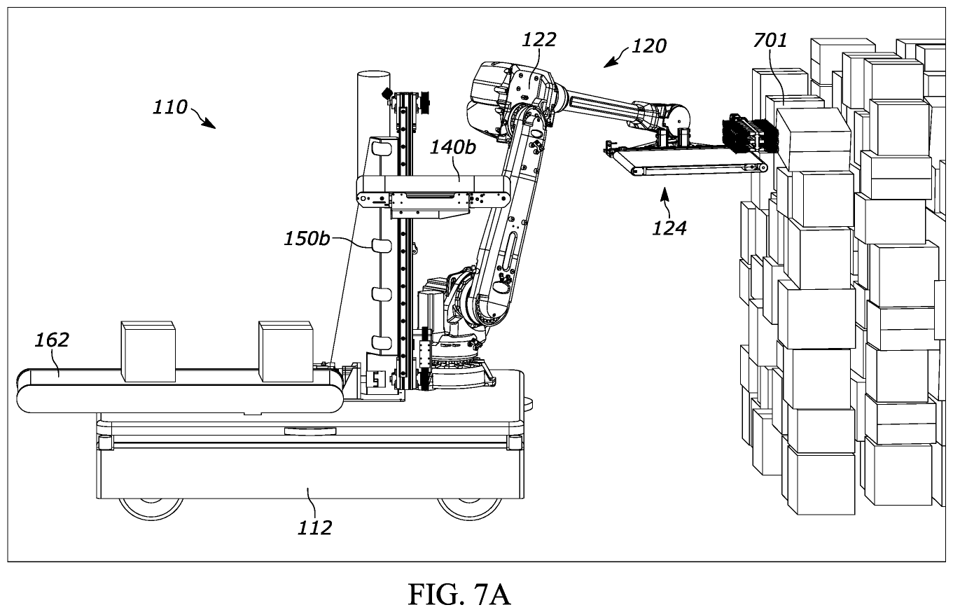

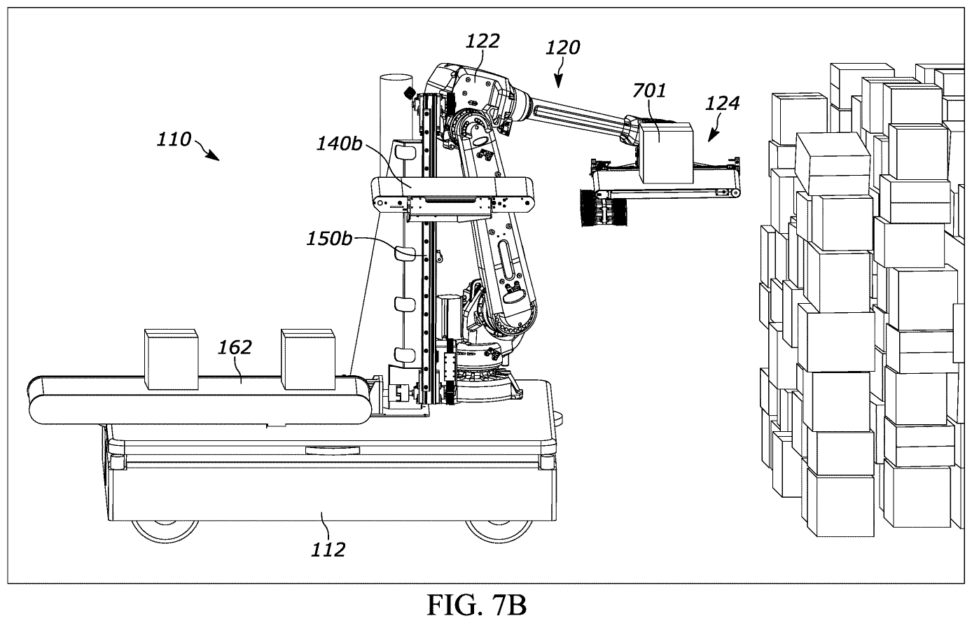

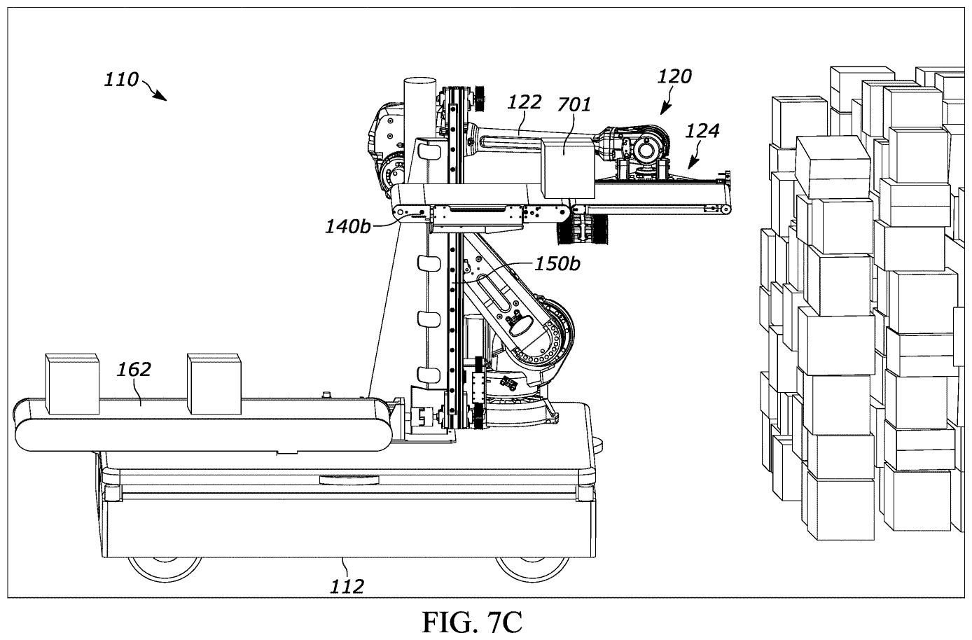

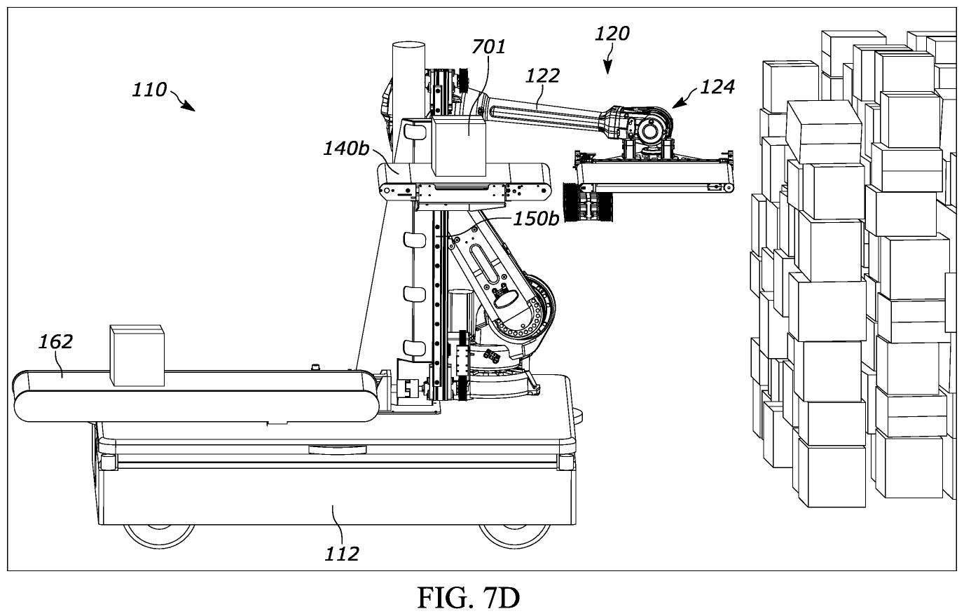

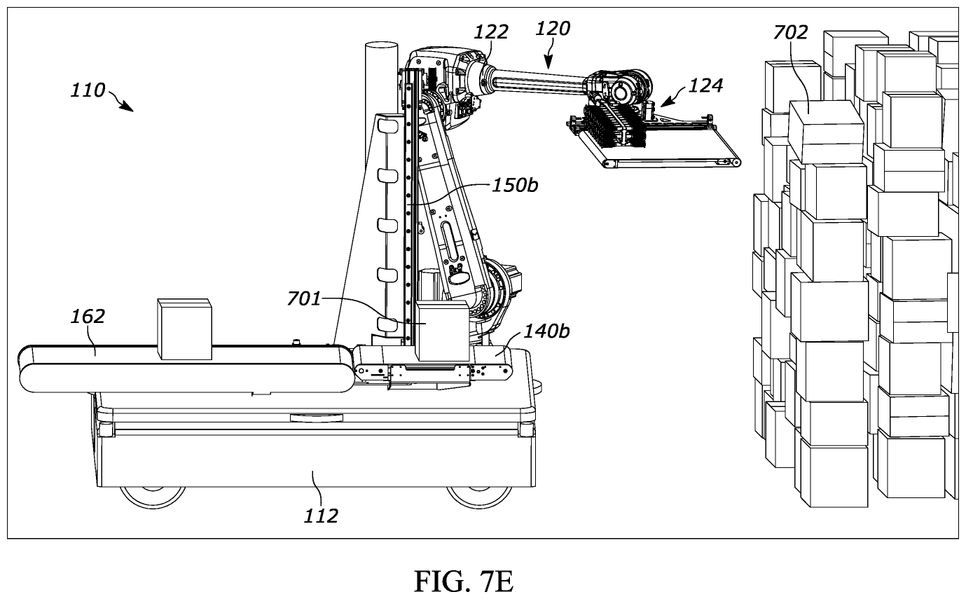

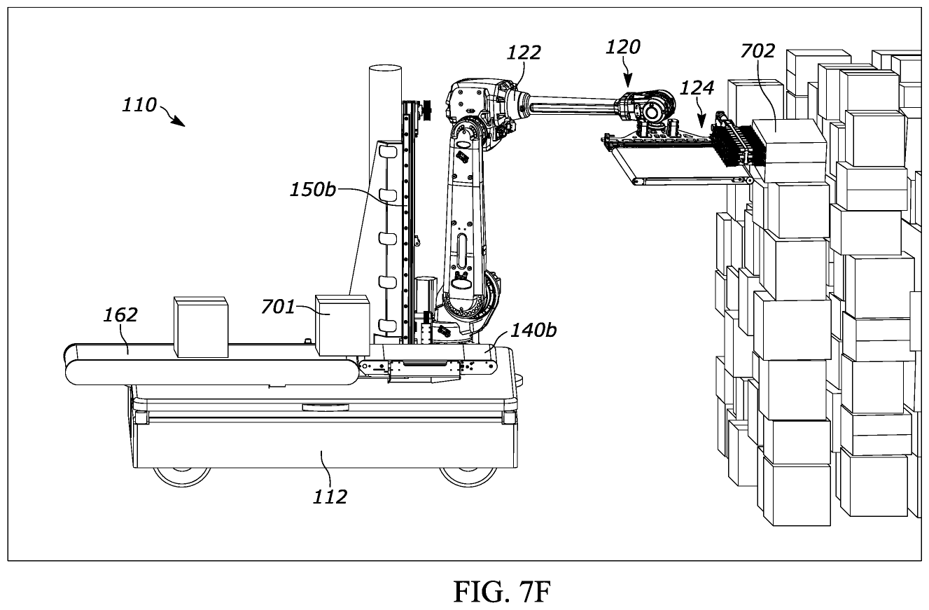

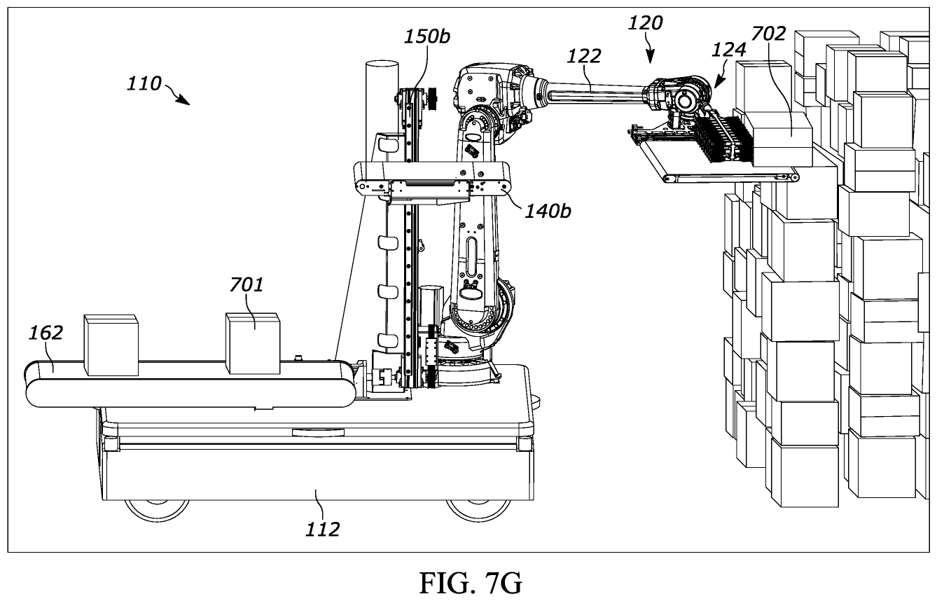

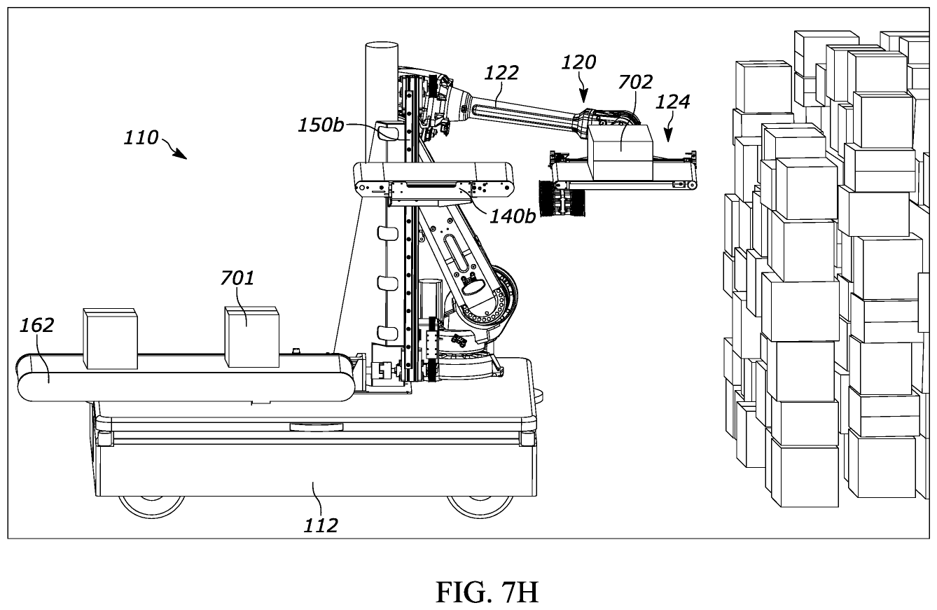

FIGS. 7A-7H depict the freight manipulator 310 in operation according to the exemplary method 600 of FIG. 6. FIG. 7A illustrates the freight manipulator 310 picking, with the pick apparatus 120, an object 701. FIG. 7B illustrates the freight manipulator 310 moving, with the pick apparatus 120, the picked object 701 toward the elevating conveyor 140b. FIG. 7C illustrates the pick apparatus 120 releasing, with the EoAT 124 of the pick apparatus 120, the picked object 701 to the elevating conveyor 140b in step 602. FIG. 7D illustrates that the object 701 has been transferred from the pick apparatus 120 to the elevating conveyor 140b. FIG. 7E illustrates the elevating conveyor 140b has been lowered, with the elevating conveyor actuator 150b, in step 612 and also illustrates the pick apparatus 120 moving toward the next object 702 in step 606. Before moving toward the next object in step 606, the system may determine the next object location in step 604. FIG. 7F illustrates the pick apparatus 120, with the EoAT 124, picking the next object 702 in step 608 and also illustrates the elevating conveyor 140b moving the object 701 off the elevating conveyor 140b in step 614. FIG. 7G illustrates the pick apparatus 120 moving the next object 702 toward the elevating conveyor 140b in step 610 and also illustrates the elevating conveyor actuator 150b raising up the elevating conveyor 140b in step 616. FIG. 7H continuously illustrates the pick apparatus moving the next object 702 toward the elevating conveyor 140b in step 610.

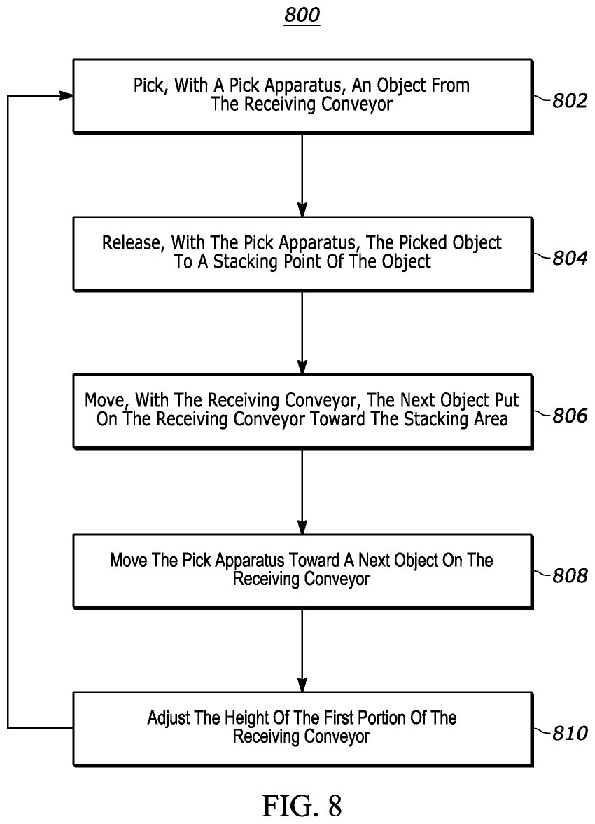

FIG. 8 is a flowchart depicting another exemplary method 800 to manipulate objects in a commercial product facility that may be performed using the system 100 in accordance with the embodiments described above. Although the method 800 is mainly illustrated with the system 100 including the freight manipulator 110, the method 800 may also be performed with the system 100 including the freight manipulator 210 or 310. The method 800 may be performed to load a container/trailer by stacking objects. In some embodiments, the loading process may comprise a reverse motion/process of the unloading process of the method 400. The flow begins at step 802.

In step 802, the pick apparatus 120 picks an object from the receiving conveyor 140 with the pick apparatus approaching edge 142a, 142b at a third height. The pick apparatus 120 may pick the object from the receiving conveyor 140 with the EoAT 124.

In step 804, the pick apparatus 120 releases the picked object to a stacking point of the object. To release the picked object to the stacking point of the object, the pick apparatus 120 may move the picked object toward the stacking point of the picked object. The stacking point may be a targeted point in a stacking area where the object to be put or released to form a stack of objects in a container/trailer in a loading scenario. For example, the stacking point may correspond to the specific position of each object in the stack of the objects after completing loading process. In some embodiments, the sensor devices 170 of the system 100 may capture the image of the stacking area, and the control circuit 184 may determine the stacking point of the object based on the captured and recognized image of the stacking area.

In step 806, the receiving conveyor 140 moves the next object on the receiving conveyor 140 toward the stacking area. For example, to move the next object toward the stacking area, the receiving conveyor 140 moves an object thereon toward the edge which is closer to the stacking area than the opposite edge. The edge closer to the stacking point may be a pick apparatus approaching edge. In some embodiments, the next object may be put on the receiving conveyor 140 with the discharging conveyor 190 transferring an object thereon to the receiving conveyor 140 in the loading scenario. In some embodiments, step 806 may be conducted while step 804 is conducted.

In step 808, the pick apparatus 120 moves toward the next object on the receiving conveyor 140. In some aspects, the pick apparatus 120 moves toward the next object on the receiving conveyor 140 while the receiving conveyor 140 moves the next object toward the stacking point of the next object. In some embodiments, the pick apparatus 120 may be disposed between the receiving conveyor 140 and stacking points of objects such that approaching the next object on the receiving conveyor 140 may cause the pick apparatus 120 to move away from the stacking points of objects.

In some embodiments, step 806 may be conducted while one or more steps 804 and 808 are conducted. In one aspect, step 806 may be conducted while step 804 is conducted. In one aspect, step 806 may also be conducted while step 808 is conducted. For example, receiving conveyor 140 moves the next object on the receiving conveyor 140 toward the stacking point of the next object (e.g., toward the conveyor edge closer to the stacking area) while the pick apparatus 120 approaches the next object on the receiving conveyor 140. In one aspect, step 806 may be conducted while steps 804 and 808 are conducted.

In step 810, the height of the height adjustable portion of the receiving conveyor 140 is adjusted before the pick apparatus 120 picks the next object on the receiving conveyor 140. The height of the height adjustable portion of the receiving conveyor may be adjusted similarly to step 410 above. In some embodiments, the control circuit 184 determines and causes the receiving conveyor actuator 150 to adjust the height of the pick apparatus approaching edge of the receiving conveyor 140 from the third height to a fourth height based the stacking point of the object and/or the stacking point of the next object. The receiving conveyor actuator 150 adjusts the height of the pick apparatus approaching edge of the receiving conveyor 140 before the pick apparatus 120 picks the next object on the receiving conveyor 140. For example, the receiving conveyor actuator 150 adjusts the height of the pick apparatus approaching edge the receiving conveyor 140 while system 100 conducts one or more of steps 804, 806, and 808.

The steps illustrated in FIG. 8 may be repeated to manipulate more than two objects. For example, the flow may continue after step 810, going back to step 802. Steps 802 to 810 may be repeated as many times as necessary. For example, steps 802 to 810 may be repeated until there remain no objects the system 100 should manipulate according to the method 800, or until the system 100 identifies no case to be gripped.

In some embodiments, a system for freight manipulation may comprise, a mobile platform comprising a moving mechanism, a receiving conveyor on the mobile platform, wherein a height of a first portion of the receiving conveyor is controllable, a receiving conveyor actuator coupled to the receiving conveyor configured to change the height of the first portion of the receiving conveyor, a pick apparatus attached to the mobile platform, and a control circuit operably coupled to the receiving conveyor, the receiving conveyor actuator, and the pick apparatus, the control circuit configured to cause the pick apparatus to pick a first object from a stack of objects and release the first object to the receiving conveyor with the first portion at a first height, cause the receiving conveyor to move away the first object released thereon from the stack of objects, cause the pick apparatus to move toward a second object in the stack of objects while the first object on the receiving conveyor is moved away from the stack of objects, and cause the receiving conveyor actuator to change, based at least on a height of the second object, the height of the first portion of the receiving conveyor from the first height to a second height before the second object is transferred from the pick apparatus to the receiving conveyor.

In some embodiments, a method for freight manipulation may comprise picking, with a pick apparatus attached to a mobile platform, a first object from a stack of objects, releasing, with the pick apparatus, the first object to a receiving conveyor with a first portion at a first height, wherein the receiving conveyor is on the mobile platform, moving, with the receiving conveyor, the first object released on the receiving conveyor away from the stack of objects, moving the pick apparatus toward a second object in the stack of objects while the first object released on the receiving conveyor is moved away from the stack of objects, and adjusting, with a receiving conveyor actuator and based at least on a height of the second object in the stack of objects, the height of the first portion of the receiving conveyor from the first height to a second height before the second object is transferred from the pick apparatus to the receiving conveyor.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system for freight manipulation, the system comprising:
a mobile platform comprising a moving mechanism;
a receiving conveyor on the mobile platform, wherein a height of a first portion of the receiving conveyor is controllable;
a receiving conveyor actuator coupled to the receiving conveyor configured to change the height of the first portion of the receiving conveyor;
a pick apparatus attached to the mobile platform; and
a control circuit operably coupled to the receiving conveyor, the receiving conveyor actuator, and the pick apparatus, the control circuit configured to:
cause the pick apparatus to pick a first object from a stack of objects and release the first object to the receiving conveyor with the first portion at a first height;
cause the receiving conveyor to move away the first object released thereon from the stack of objects;
cause the pick apparatus to move toward a second object in the stack of objects while the first object on the receiving conveyor is moved away from the stack of objects; and
cause the receiving conveyor actuator to change, based at least on a height of the second object, the height of the first portion of the receiving conveyor from the first height to a second height before the second object is transferred from the pick apparatus to the receiving conveyor.

2. The system of claim 1, wherein the control circuit is further configured to lower the first portion of the receiving conveyor while raising the pick apparatus.

3. The system of claim 1, wherein the control circuit is configured to control (or determine) the height of the first portion of the receiving conveyor based on a pick location of an object in the stack and a pick location of a next object being picked in the stack.

4. The system of claim 1, wherein the height of the first portion of the receiving conveyor is determined based on minimizing a total distance between a pick location of an object and the receiving conveyor and between the receiving conveyor and a pick location of a next object being picked.

5. The system of claim 1, wherein the pick apparatus is configured to support a full weight of an object while moving the object from a pick location to a release location on the receiving conveyor.

6. The system of claim 1 further comprising a fixed height conveying mechanism configured to receive an object from the receiving conveyor.

7. The system of claim 1, wherein the receiving conveyor comprises a tilting conveyor and the first portion of the receiving conveyor is a first edge of the tilting conveyor.

8. The system of claim 7, wherein the tilting conveyor comprises a fixed height portion.

9. The system of claim 7, wherein a second edge opposite the first edge of the tilting conveyor has a fixed height.

10. The system of claim 1, wherein the receiving conveyor comprises an elevating conveyor configured to move up and down and the receiving conveyor actuator is configured to raise and lower the elevating conveyor.

11. The system of claim 10, wherein the elevating conveyor is configured to only move vertically on the mobile platform.

12. The system of claim 10 further comprising a fixed height conveying mechanism configured to receive an object from the elevating conveyor, wherein the elevating conveyor is configured to be in alignment with the fixed height conveying mechanism in a lowest position.

13. The system of claim 1, wherein the moving mechanism of the mobile platform comprise one or more wheels, and/or tracks.

14. The system of claim 1, wherein the receiving conveyor is configured to move forward, backward, and/or sideways.

15. The system of claim 1, wherein the pick apparatus comprises a robotic arm attached to the mobile platform and an end of arm tool (EoAT) coupled to the robotic arm.

16. The system of claim 1, wherein the first portion of the receiving conveyor does not extend outside of an area corresponding to the mobile platform.

17. The system of claim 1 further comprising a sensor device configured to recognize object height, and wherein the control circuit is further configured to determine the height of the first portion of the receiving conveyor based on the recognized object height.

18. The system of claim 1, wherein the control circuit is further configured to:
cause the pick apparatus to pick a third object from the receiving conveyor with the first portion at a third height;
cause the pick apparatus to release the third object on a stacking point of the third object;
cause the receiving conveyor to move a fourth object on the receiving conveyor toward a stacking area;
cause the pick apparatus to move toward the fourth object on the receiving conveyor while the fourth object on the receiving conveyor is moved toward the stacking area; and
cause the receiving conveyor actuator to adjust, based on the stacking point of the third object and/or a stacking point of the fourth object, the height of the first portion of the receiving conveyor from the third height to a fourth height before the pick apparatus picks the fourth object on the receiving conveyor.

19. A method for freight manipulation, the method comprising:
picking, with a pick apparatus attached to a mobile platform, a first object from a stack of objects;
releasing, with the pick apparatus, the first object to a receiving conveyor with a first portion at a first height, wherein the receiving conveyor is on the mobile platform;
moving, with the receiving conveyor, the first object released on the receiving conveyor away from the stack of objects;
moving the pick apparatus toward a second object in the stack of objects while the first object released on the receiving conveyor is moved away from the stack of objects; and
adjusting, with a receiving conveyor actuator and based at least on a height of the second object in the stack of objects, the height of the first portion of the receiving conveyor from the first height to a second height before the second object is transferred from the pick apparatus to the receiving conveyor.

20. The method of claim 19 further comprising:
picking, with the pick apparatus, a third object from the receiving conveyor with the first portion at a third height;
releasing, with the pick apparatus, the third object on a stacking point of the third object;
moving, with the receiving conveyor, a fourth object on the receiving conveyor toward a stacking area;
moving the pick apparatus toward the fourth object on the receiving conveyor while the fourth object on the receiving conveyor is moved toward the stacking area; and
adjusting, with the receiving conveyor actuator and based on the stacking point of the third object and/or a stacking point of the fourth object, the height of the first portion of the receiving conveyor from the third height to a fourth height before the pick apparatus picks the fourth object on the receiving conveyor.
